(19) United States
(12) Patent Application Publication
(10) Pub. No.: US 2009/0153828 A1
(43) Pub. Date: Jun. 18, 2009

(54) EXPOSURE APPARATUS, EXPOSURE METHOD, AND DEVICE FABRICATION METHOD

(75) Inventor: Nobuhiko Yabu, Utsunomiya-shi (JP)

Correspondence Address: Locke Lord Bissell & Liddell LLP;Attn: IP Docketing, Three World Financial Center, New York, NY, 10281-2101, US

(73) Assignee: CANON KABUSHIKI KAISHA, Tokyo (JP)

(21) Appl. No.: 12/334,675

(22) Filed: Dec. 15, 2008

(30) Foreign Application Priority Data
Dec. 18, 2007 (JP) 2007-326584

(51) Int. Cl. G03B 27/54

(52) U.S. Cl. 355/67

(57) ABSTRACT

The present invention provides an exposure apparatus comprising a projection optical system configured to project a pattern of a reticle onto a substrate, a specifying unit configured to specify a first region on a pupil plane of the projection optical system based on the pattern of the reticle and a shape of an effective light source on the pupil plane of the projection optical system, and an adjusting unit configured to adjust an aberration of the projection optical system, wherein the adjusting unit adjusts the aberration of the projection optical system so that an aberration in the first region specified by the specifying unit becomes smaller than an aberration in a second region on the pupil plane of the projection optical system, which is different from the first region.

### BACKGROUND OF THE INVENTION

1. Field of the Invention

The present invention relates to an exposure apparatus, an exposure method, and a device fabrication method.

2. Description of the Related Art

A projection exposure apparatus has conventionally been employed to fabricate a micropatterned semiconductor device such as an LSI or VLSI by using photolithography. The projection exposure apparatus projects a pattern formed on a reticle (mask) onto a substrate such as a wafer via a projection optical system.

Along with the recent increase in demand for advance in micropatterning of semiconductor devices, a higher resolving power is becoming necessary for the projection optical system of the exposure apparatus. For this reason, if an aberration that is non-negligible from the viewpoint of satisfying a required resolving power is generated in the projection optical system, this aberration (i.e., the imaging state of light which passes through the projection optical system) must be corrected. See Japanese Patent Laid-Open No. 2006-173305 for details of this technique.

Under the current circumstances, Japanese Patent Laid-Open No. 4-30411 proposes an exposure apparatus which adjusts the wavefront (aberration) of a projection optical system on its pupil plane by controlling, for example, the position, orientation, and shape of a specific optical element (e.g., a lens or mirror) in the projection optical system. More specifically, Japanese Patent Laid-Open No. 4-30411 discloses an exposure apparatus which includes a driving unit for driving at least one lens system in a projection optical system in the optical axis direction, and a wavelength changing unit for changing the oscillation wavelength of light that illuminates a reticle, and which can adjust the magnification and distortion aberration of the projection optical system.

In the prior arts, the aberration is adjusted assuming the entire region on the pupil plane of the projection optical system as the aberration adjustment target region without taking account of the reticle pattern and the shape of an effective light source formed on the pupil plane of the projection optical system. However, the inventor of the present invention found that in modified illumination using an effective light source having a dipole shape or quadrupole shape, the aberration is preferably adjusted assuming not the entire region on the pupil plane of the projection optical system but a partial region that significantly contributes to imaging as the aberration adjustment target region. Assume that the aberration is adjusted assuming the entire region on the pupil plane of the projection optical system as the aberration adjustment target region. In this case, particularly aberration components rotationally asymmetrical about the optical axis, such as 2θ-, 3θ-, and 4θ-symmetric aberration components, often cannot be adjusted up to a required accuracy in a partial region that significantly contributes to imaging.

### SUMMARY OF THE INVENTION

The present invention provides an exposure apparatus which attains excellent imaging characteristics by accurately adjusting the imaging state (e.g., the aberration) of light which passes through a projection optical system in a partial region on the pupil plane of the projection optical system.

According to the first aspect of the present invention, there is provided an exposure apparatus comprising a projection optical system configured to project a pattern of a reticle onto a substrate, a specifying unit configured to specify a first region on a pupil plane of the projection optical system based on the pattern of the reticle and a shape of an effective light source on the pupil plane of the projection optical system, and an adjusting unit configured to adjust an aberration of the projection optical system, wherein the adjusting unit adjusts the aberration of the projection optical system so that an aberration in the first region specified by the specifying unit becomes smaller than an aberration in a second region on the pupil plane of the projection optical system, which is different from the first region.

According to the second aspect of the present invention, there is provided an exposure method using an exposure apparatus including a projection optical system which projects a pattern of a reticle onto a substrate, comprising a specifying step of specifying a first region on a pupil plane of the projection optical system based on the pattern of the reticle and a shape of an effective light source on the pupil plane of the projection optical system, and an adjusting step of adjusting an aberration of the projection optical system, wherein in the adjusting step, the aberration of the projection optical system is adjusted so that an aberration in the first region specified in the specifying step becomes smaller than an aberration in a second region on the pupil plane of the projection optical system, which is different from the first region.

According to the third aspect of the present invention, there is provided a device fabrication method comprising steps of exposing a substrate using an exposure apparatus, and performing a development process for the substrate exposed, wherein the exposure apparatus includes a projection optical system configured to project a pattern of a reticle onto the substrate, a specifying unit configured to specify a first region on a pupil plane of the projection optical system based on the pattern of the reticle and a shape of an effective light source on the pupil plane of the projection optical system, and an adjusting unit configured to adjust an aberration of the projection optical system, wherein the adjusting unit adjusts the aberration of the projection optical system so that an aberration in the first region specified by the specifying unit becomes smaller than an aberration in a second region on the pupil plane of the projection optical system, which is different from the first region.

Further features of the present invention will become apparent from the following description of exemplary embodiments with reference to the attached drawings.

### BRIEF DESCRIPTION OF THE DRAWINGS

FIG. 1 is a schematic block diagram showing the arrangement of an exposure apparatus according to one aspect of the present invention.

FIG. 2 is a flowchart for explaining the aberration adjustment of a projection optical system in the exposure apparatus shown in FIG. 1.

FIG. 3 is a chart showing the aberration component expressed by the Zernike coefficient of the 4th term in the Zernike polynomial.

FIG. 4 is a chart showing the aberration component expressed by the Zernike coefficient of the 9th term in the Zernike polynomial.

FIG. 5 is a view showing an example of the shape of an effective light source formed by an illumination optical system of the exposure apparatus shown in FIG. 1.

FIG. 6 is a view showing an example of the pattern of a reticle in the exposure apparatus shown in FIG. 1.

FIG. 7 is a view showing a partial region on the pupil plane of the projection optical system, which is specified from the pattern of the reticle shown in FIG. 6 and the shape of the effective light source shown in FIG. 5.

FIG. 8 is a chart showing the aberration of the projection optical system acquired in step S1004 of FIG. 2.

FIG. 9 is a chart showing the aberration of the projection optical system after aberration correction in step S1008 of FIG. 2.

FIG. 10 is a graph showing the sections of the aberrations of the projection optical system shown in FIGS. 8 and 9 on the X-axis.

FIG. 11 is a graph showing a variation ΔCD in the line width of a main pattern when the reticle shown in FIG. 6 is exposed.

FIG. 12 is a chart showing the aberration of the projection optical system before aberration correction in the exposure apparatus shown in FIG. 1.

FIG. 13 is a chart showing the aberration of the projection optical system after the aberration in the partial region on the pupil plane of the projection optical system is corrected in the exposure apparatus shown in FIG. 1.

FIG. 14 is a view showing an example of the shape of an effective light source formed by the illumination optical system of the exposure apparatus shown in FIG. 1.

FIG. 15 is a view showing the pattern of a reticle used for the effective light source shown in FIG. 14.

FIG. 16 is a view showing a partial region on the pupil plane of the projection optical system, which is specified from the pattern of the reticle shown in FIG. 15 and the shape of the effective light source shown in FIG. 14.

FIG. 17 is a chart showing the aberration of the projection optical system before aberration correction in the exposure apparatus shown in FIG. 1.

FIG. 18 is a chart showing the aberration of the projection optical system after the aberration in the partial region on the pupil plane of the projection optical system is corrected in the exposure apparatus shown in FIG. 1.

FIG. 19 is a view showing an example of the shape of an effective light source formed by the illumination optical system of the exposure apparatus shown in FIG. 1.

FIG. 20 is a view showing a partial region on the pupil plane of the projection optical system, which is specified from the pattern of the reticle shown in FIG. 15 and the shape of the effective light source shown in FIG. 19.

### DESCRIPTION OF THE EMBODIMENT

A preferred embodiment of the present invention will be described below with reference to the accompanying drawings. Note that the same reference numerals denote the same members throughout the drawings, and a repetitive description thereof will not be given.

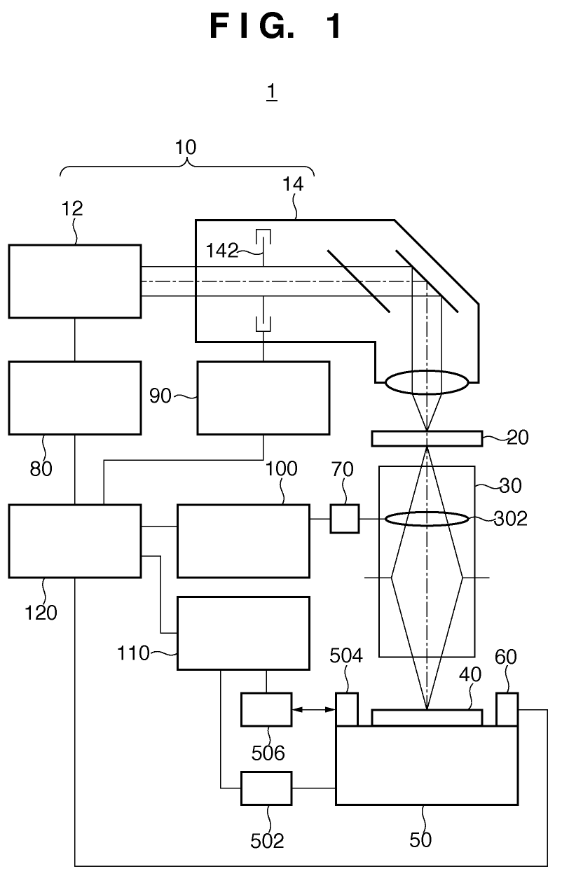

FIG. 1 is a schematic block diagram showing the arrangement of an exposure apparatus 1 according to one aspect of the present invention. In this embodiment, the exposure apparatus 1 is a projection exposure apparatus which projects the pattern of a reticle 20 onto a wafer 40, thereby exposing the wafer 40 by the step & scan scheme. However, the exposure apparatus 1 can also adopt the step & repeat scheme or another exposure scheme.

The exposure apparatus 1 includes an illumination apparatus 10, a reticle stage for mounting the reticle 20, a projection optical system 30, a wafer stage 50 for mounting the wafer 40, a measuring unit 60, and a lens driving unit 70. The exposure apparatus 1 also includes a light source control unit 80, illumination system control unit 90, projection system control unit 100, stage control unit 110, and main control unit 120.

The illumination apparatus 10 illuminates the reticle 20 on which a pattern to be transferred is formed, and includes a light source 12 and illumination optical system 14.

In this embodiment, the light source 12 is an ArF excimer laser which emits light having a wavelength of about 193 nm (ultraviolet light). However, the light source 12 is not particularly limited to an ArF excimer laser, and may be, for example, a KrF excimer laser, F₂ laser, or superhigh pressure mercury lamp.

The illumination optical system 14 illuminates the reticle 20 with the light from the light source 12, and includes, for example, a lens, mirror, optical integrator, polarization adjusting unit, and light amount adjusting unit. The illumination optical system 14 can attain various types of modified illumination such as quadrupole illumination and dipole illumination, as will be described later. In this embodiment, the illumination optical system 14 includes an aperture stop 142 at a position nearly conjugate to that of an effective light source formed on the pupil plane of the projection optical system 30. The aperture shape of the aperture stop 142 corresponds to the light intensity distribution (i.e., the shape of the effective light source) on the pupil plane of the projection optical system 30. However, the illumination optical system 14 may form an effective light source using a diffractive optical element (e.g., a CGH) or a prism in place of the aperture stop 142.

The reticle 20 has a pattern to be transferred, and is supported and driven by the reticle stage (not shown). Light diffracted by the pattern of the reticle 20 is projected onto the wafer 40 via the projection optical system 30. The reticle 20 and wafer 40 are set to hold an optically conjugate relationship. Since the exposure apparatus 1 is of the step & scan scheme, it transfers the pattern of the reticle 20 onto the wafer 40 by scanning them.

The projection optical system 30 projects the pattern of the reticle 20 onto the wafer 40. Although the projection optical system 30 includes a plurality of optical elements (e.g., a lens and mirror), only one optical element 302 is shown in FIG. 1.

The wafer 40 is a substrate onto which the pattern of the reticle 20 is projected (transferred). However, it is also possible to use a glass plate or another substrate in place of the wafer 40. The wafer 40 is coated with a photoresist (photosensitive agent).

The wafer stage 50 supports the wafer 40 and is connected to a stage driving unit 502 such as a linear motor. The stage driving unit 502 drives the wafer stage 50 three-dimensionally (i.e., in the optical axis direction of the projection optical system 30 (Z direction), and on a plane perpendicular to the optical axis of the projection optical system 30 (X-Y plane)). A mirror 504 which can be detected by a laser interferometer 506 is arranged (fixed) on the wafer stage 50.

The measuring unit 60 measures the aberration of the projection optical system 30 (aberration components rotationally symmetrical and asymmetrical about the optical axis of the projection optical system 30) using, for example, a point diffraction interferometer (PDI), line diffraction interferometer, and shearing interferometer. The measuring unit 60 sends the measurement result (i.e., the aberration of the projection optical system 30) to the main control unit 120. However, the aberration of the projection optical system 30 may be acquired by transferring a predetermined pattern onto a wafer, and observing the predetermined pattern transferred onto the wafer by, for example, an SEM, or may be obtained by simulation based on, for example, the design value and exposure conditions of the projection optical system 30.

The lens driving unit 70 drives an optical element (the optical element 302 in this embodiment) which forms the projection optical system 30 under the control of the projection system control unit 100. More specifically, using, for example, the air pressure or a piezoelectric element, the lens driving unit 70 drives the optical element 302 in the optical axis direction of the projection optical system 30, tilts the optical element 302 with respect to a plane perpendicular to the optical axis of the projection optical system 30, or deforms the optical element 302.

The light source control unit 80 controls the light source 12 to stabilize the wavelength of light emitted by the light source 12.

The illumination system control unit 90 controls the illumination optical system 14. In this embodiment, the illumination system control unit 90 controls the aperture shape of an aperture stop 142 and the switching between aperture stops 142 having different aperture shapes to form a desired effective light source. Also, the illumination system control unit 90 controls the polarization adjusting unit (not shown) to form a desired polarization state, or controls the light amount adjusting unit (not shown) to adjust the light amount (exposure amount).

The projection system control unit 100 controls the projection optical system 30. In this embodiment, the projection system control unit 100 controls the driving amount of the optical element 302 of the projection optical system 30 via the lens driving unit 70. The driving amount of the optical element 302 includes a driving amount in driving the optical element 302 in the optical axis direction of the projection optical system 30, a tilt amount in tilting the optical element 302 with respect to a plane perpendicular to the optical axis of the projection optical system 30, and a deformation amount in deforming the optical element 302. Also, the projection system control unit 100 controls the aperture diameter of an aperture stop (not shown) inserted on the pupil plane of the projection optical system 30 to adjust the numerical aperture (NA) of the projection optical system 30.

The stage control unit 110 controls the wafer stage 50. More specifically, the stage control unit 110 calculates the position of the wafer stage 50 (on the X-Y plane) from the detection result obtained by the laser interferometer 506 (the distance between the laser interferometer 506 and the mirror 504). Based on the calculation result, the stage control unit 110 controls the stage driving unit 502 to drive the wafer stage 50 to a predetermined position.

The main control unit 120 controls the overall exposure apparatus 1 (the operation of the exposure apparatus 1) via, for example, the light source control unit 80, illumination system control unit 90, projection system control unit 100, and stage control unit 110. The main control unit 120 may have the functions of the light source control unit 80, illumination system control unit 90, projection system control unit 100, and stage control unit 110. In other words, the light source control unit 80, illumination system control unit 90, projection system control unit 100, and stage control unit 110 may be integrated with the main control unit 120.

In this embodiment, the main control unit 120 drives the optical element 302 of the projection optical system 30 via the projection system control unit 100, thereby adjusting the aberration of the projection optical system 30 to a predetermined state. As will be described later, the main control unit 120 serves as a specifying unit, which specifies a partial region on the pupil plane of the projection optical system 30 as the aberration adjustment target region based on the pattern of the reticle 20 and the shape of the effective light source on the pupil plane of the projection optical system 30. More specifically, the main control unit 120 has a table representing the correspondence between the partial region on the pupil plane of the projection optical system 30 and the pattern of the reticle 20 and the shape of the effective light source on the pupil plane of the projection optical system 30, and specifies the partial region by referring to this table. A table representing the correspondence between the partial region on the pupil plane of the projection optical system 30 and the pattern of the reticle 20 and the shape of the effective light source on the pupil plane of the projection optical system 30 can be generated by, for example, an optical simulator or user's experience. The main control unit 120 serves as an adjusting unit in cooperation with the projection system control unit 100 and lens driving unit 70, and adjusts the aberration of the projection optical system 30 in the specified partial region on the pupil plane of the projection optical system 30.

The partial region specified by the main control unit 120 is a region that exerts an influence on the imaging state of light which passes through the projection optical system 30 (i.e., a region that significantly contributes to imaging). An example of this partial region is a region irradiated with light diffracted by the pattern of the reticle 20. This partial region is one of a point region, line region, plane region, and a combination thereof (e.g., a band-like region).

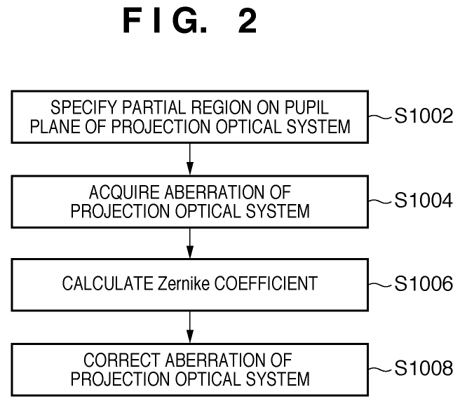

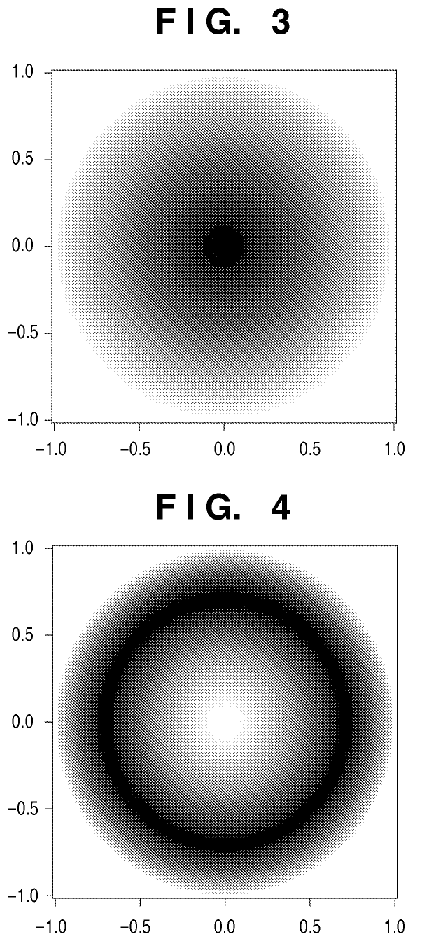

The aberration adjustment of the projection optical system 30 by the main control unit 120 will be explained below with reference to FIG. 2. FIG. 2 is a flowchart for explaining the aberration adjustment of the projection optical system 30 in the exposure apparatus 1. Note that the aberration of the projection optical system 30 is expressed by the Zernike polynomial in this embodiment. The aberration components of the projection optical system 30, which can be adjusted by the main control unit 120, are aberration components rotationally symmetrical about the optical axis of the projection optical system 30 and, for example, only the aberration components corresponding to the Zernike coefficients of the 4th and 9th terms in the Zernike polynomial as shown in FIGS. 3 and 4. FIG. 3 is a chart showing the aberration component expressed by the Zernike coefficient of the 4th term in the Zernike polynomial. FIG. 4 is a chart showing the aberration component expressed by the Zernike coefficient of the 9th term in the Zernike polynomial. Although the exposure apparatus in this embodiment adjusts only the Zernike coefficients of the 4th and 9th terms, the technique according to this embodiment is also applicable to an exposure apparatus which can adjust the Zernike coefficients of other terms. This makes it possible to further increase the degree of freedom of the aberration adjustment by the exposure apparatus.

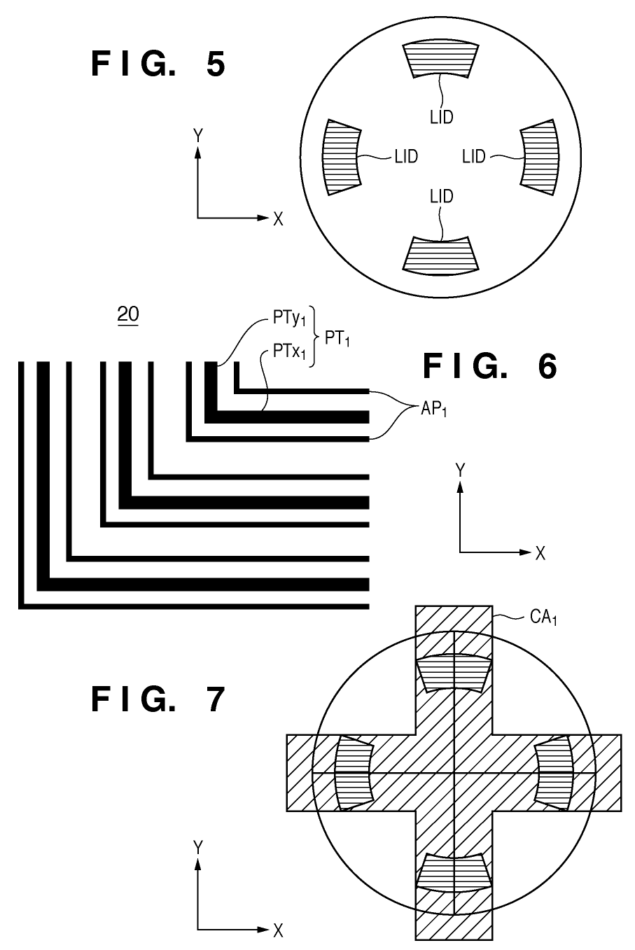

In this embodiment, the illumination optical system 14 forms an effective light source (the shape of an effective light source) as shown in FIG. 5 on the pupil plane of the projection optical system 30. The effective light source shown in FIG. 5 has a quadrupole shape having light intensity distributions LID in two divided regions on a first axis (on the X-axis) in the pupil plane of the projection optical system 30, and two divided regions on a second axis (on the Y-axis) perpendicular to the first axis. Also, the effective light source shown in FIG. 5 is obtained by extracting an annular zone defined by σ=0.85 and an annular ratio=4/5 at an extraction angle=30°. Note that FIG. 5 is a view showing an example of the shape of an effective light source formed by the illumination optical system 14. The first axis (X-axis) corresponds to a straight line which passes through the center of the pupil (optical axis) of the projection optical system 30 and is perpendicular to the scanning direction of the exposure apparatus 1.

This embodiment uses a reticle 20 having a main pattern PT₁ including a pattern PTₓ₁ parallel to the X-axis and a pattern PT_{y1} parallel to the Y-axis, and auxiliary patterns AP₁ formed on both sides of the main pattern PT₁, as shown in FIG. 6. As described above, because the main pattern PT₁ of the reticle 20 is a mixture of the pattern PTₓ₁ parallel to the X-axis and the pattern PT_{y1} parallel to the Y-axis, light diffracted by the reticle 20 (main pattern PT₁) propagates in the X- and Y-axis directions. Note that FIG. 6 is a view showing an example of the pattern of the reticle 20.

First, the main control unit 120 specifies a partial region on the pupil plane of the projection optical system 30 as the aberration correction target region based on the pattern of the reticle 20 and the shape of the effective light source on the pupil plane of the projection optical system 30 (step S1002). In this embodiment, the main control unit 120 specifies a partial region CA₁ on the pupil plane of the projection optical system 30 as shown in FIG. 7, based on the pattern of the reticle 20 shown in FIG. 6 and the shape of the effective light source shown in FIG. 5. The partial region CA₁ is a region irradiated with light diffracted by the main pattern PT₁ of the reticle 20 shown in FIG. 5 on the pupil plane of the projection optical system 30. The light diffracted by the main pattern PT₁ of the reticle 20 shown in FIG. 5 is distributed near the X- and Y-axes on the pupil plane of the projection optical system 30. In this manner, the main control unit 120 specifies, as the partial region CA₁, a band-like region which extends in the X-axis direction and includes two regions in which the light intensity distributions LID are formed, and a band-like region which extends in the Y-axis direction and includes two regions in which the light intensity distributions LID are formed. Note that FIG. 7 is a view showing the partial region CA₁ on the pupil plane of the projection optical system 30, which is specified from the pattern of the reticle 20 shown in FIG. 6 and the shape of the effective light source shown in FIG. 5.

Next, the main control unit 120 controls the measuring unit 60 to measure an aberration (wavefront aberration) W(ρ, θ) of the projection optical system 30 to acquire the aberration W(ρ, θ) generated in the projection optical system 30 (step S1004). Note that ρ is a normalized pupil radius obtained by normalization assuming the radius of the pupil of the projection optical system 30 as 1, and θ is the angle of the radius vector of polar coordinates set on the exit pupil plane.

The main control unit 120 fits the aberration W(ρ, θ) acquired in step S1004 into a Zernike orthogonal cylindrical function system Zₙ(ρ, θ), thereby calculating an expansion coefficient (Zernike coefficient) Cₙ of each term (step S1006). Note that the Zernike coefficient Cₙ, Zernike orthogonal cylindrical function system Zₙ(ρ, θ), and aberration W(ρ, θ) satisfy:

W(ρ,θ)=Σ(Cₙ·Zₙ(ρ,θ)) (1)

where Σ represents a sum for n which is a natural number.

The Zernike orthogonal cylindrical function system Zₙ(ρ, θ) is given by:

Z₁(ρ,θ)=1

Z₂(ρ,θ)=ρ cos θ

Z₃(ρ,θ)=ρ sin θ

Z₄(ρ,θ)=2ρ²−1

Z₅(ρ,θ)=ρ² cos θ

Z₆(ρ,θ)=ρ² sin θ

Z₇(ρ,θ)=(3ρ³−2ρ)cos θ

Z₈(ρ,θ)=(3ρ³−2ρ)sin θ

Z₉(ρ,θ)=6ρ⁴−6ρ²+1

Z₁₀(ρ,θ)=ρ³ cos 3θ

Z₁₁(ρ,θ)=ρ³ sin 3θ

Z₁₂(ρ,θ)=(4ρ⁴−3ρ²)cos 2θ

Z₁₃(ρ,θ)=(4ρ⁴−3ρ²)sin 2θ

Z₁₄(ρ,θ)=(10ρ⁵−12ρ³+3ρ)cos θ

Z₁₅(ρ,θ)=(10ρ⁵−12ρ³+3ρ)sin θ

Z₁₆(ρ,θ)=20ρ⁶−30ρ⁴+12ρ²−1

Z₁₇(ρ,θ)=ρ⁴ cos 4θ

Z₁₈(ρ,θ)=ρ⁴ sin 4θ

Z₁₉(ρ,θ)=(5ρ⁵−4ρ³)cos 3θ

Z₂₀(ρ,θ)=(5ρ⁵−4ρ³)sin 3θ

Z₂₁(ρ,θ)=(15ρ⁶−20ρ⁴+6ρ²)cos 2θ

Z₂₂(ρ,θ)=(15ρ⁶−20ρ⁴+6ρ²)sin 2θ

Z₂₃(ρ,θ)=(35ρ⁷−60ρ⁵+30ρ³−4ρ)cos θ

Z₂₄(ρ,θ)=(35ρ⁷−60ρ⁵+30ρ³−4ρ)sin θ

Z₂₅(ρ,θ)=70ρ⁸−140ρ⁶+90ρ⁴−20ρ²+1

Z₂₆(ρ,θ)=ρ⁵ cos 5θ

Z₂₇(ρ,θ)=ρ⁵ sin 5θ

Z₂₈(ρ,θ)=(6ρ⁶−5ρ⁴)cos 4θ

Z₂₉(ρ,θ)=(6ρ⁶−5ρ⁴)sin 4θ

Z₃₀(ρ,θ)=(21ρ⁷−30ρ⁵+10ρ³)cos 3θ

Z₃₁(ρ,θ)=(21ρ⁷−30ρ⁵+10ρ³)sin 3θ

Z₃₂(ρ,θ)=(56ρ⁸−104ρ⁶+60ρ⁴−10ρ²)cos 2θ

Z₃₃(ρ,θ)=(56ρ⁸−104ρ⁶+60ρ⁴−10ρ²)sin 2θ

Z₃₄(ρ,θ)=(126ρ⁹−280ρ⁷+210ρ⁵−60ρ³+5ρ)cos θ

Z₃₅(ρ,θ)=(126ρ⁹−280ρ⁷+210ρ⁵−60ρ³+5ρ)sin θ

Z₃₆(ρ,θ)=252ρ¹⁰−630ρ⁸+560ρ⁶−210ρ⁴+30ρ²−1

The 37th term (Z₃₇) and subsequent terms are not given herein.

Note that the aberration components of the projection optical system 30 expressed by the Zernike orthogonal cylindrical function system Zₙ(ρ, θ) will be merely referred to as the “nth term” hereinafter.

The main control unit 120 corrects the aberration of the projection optical system 30 in the partial region CA₁ on the pupil of the projection optical system 30, which is specified in step S1002 (step S1008).

The aberration correction of the projection optical system 30 in step S1008 will be explained in detail below.

In this embodiment, light diffracted by the pattern of the reticle 20 (see FIG. 6) is distributed near the X- and Y-axes on the pupil plane of the projection optical system 30 (partial region CA₁) (see FIG. 7), as described above. For this reason, a region on the pupil plane of the projection optical system 30, that significantly contributes to imaging (that exerts an influence on the imaging state of light which passes through the projection optical system 30), is only the partial region CA₁. Hence, adjusting (optimizing) the aberration in the partial region CA₁ alone makes it possible to practically correct the aberration of the projection optical system 30.

This embodiment uses illumination (quadrupole illumination) which allows the formation of an effective light source having a quadrupole shape (e.g., the shape of an effective light source as shown in FIG. 5), as described above. In this case, generally large 4θ-system aberration components (e.g., the Zernike coefficients of the 17th term (C₁₇) and 28th term (C₂₈)) are generated in the projection optical system 30 due to the exposure heat generation of the lens. However, the aberration correcting mechanism in the exposure apparatus according to this embodiment cannot correct (reduce) the aberration components expressed by, for example, the Zernike coefficients of the 17th term (C₁₇) and 28th term (C₂₈) (aberration components rotationally asymmetrical about the optical axis of the projection optical system 30). To solve this problem, in this embodiment, the aberration components expressed by the Zernike coefficients of the 17th term (C₁₇) and 28th term (C₂₈) are corrected by the aberration components expressed by the Zernike coefficients of the 4th term (C₄) and 9th term (C₉) in the partial region CA₁ on the pupil plane of the projection optical system 30.

FIG. 8 is a chart showing the aberration (i.e., the aberration of the projection optical system 30 before aberration correction) W(ρ, θ) of the projection optical system 30 acquired in step S1004. The aberration W(ρ, θ) of the projection optical system 30 is given by:

W(ρ,θ)=C₁₇·Z₁₇(ρ,θ)+C₂₈·Z₂₈(ρ,θ)=C₁₇·ρ⁴ cos 4θ+C₂₈(6ρ⁶−5ρ⁴)cos 4θ (2)

To correct the aberration components expressed by the Zernike coefficients of the 17th term (C₁₇) and 28th term (C₂₈), aberration components (correction amounts) C′₄ and C′₉ expressed by the Zernike coefficients of the 4th and 9th terms are given. Then, a wavefront aberration W′(ρ, θ) of the projection optical system 30 is given by:

W′(ρ,θ)=C₁₇·ρ⁴ cos 4θ+C₂₈(6ρ⁶−5ρ⁴)cos 4θ+C′₄(2ρ²)+C′₉(6ρ⁴−6ρ²) (3)

Note that a constant term is ignored because it does not exert an influence on the imaging state of light which passes through the projection optical system 30.

An aberration W′_{XY-Axis}(ρ) on the X- and Y-axes (θ=0, π/2, π, 3π/2) of the pupil plane of the projection optical system 30 is given by:

W′_{XY-Axis}(ρ)=C₁₇·ρ⁴+C₂₈(6ρ⁶−5ρ⁴)+C′₄(2ρ²)+C′₉(6ρ⁴−6ρ²) (4)

Equation (4) is rewritten as a polynomial for the normalized pupil radius ρ:

W′_{XY-Axis}(ρ)=6C₂₈ρ⁶+(6C₉+C₁₇−5C₂₈)ρ⁴+(2C′₄−6C′₉)ρ²+(−C′₄+6C′₉) (5)

In this embodiment, correction amounts C′₄ and C′₉ that minimize the RMS value of the aberration W′ of the projection optical system 30 in an evaluation range (the partial region CA₁ on the pupil plane of the projection optical system 30) are calculated. Assume that correction only in a region on the X- and Y-axes of the pupil plane of the projection optical system 30 amounts to correction over the entire region CA₁ herein. This assumption can be established because the region CA₁ lies near the X- and Y-axes, which can facilitate the calculation. More specifically, letting F_{RMS} be the RMS value of the aberrations at n points equidistantly aligned on the X-axis of the pupil plane of the projection optical system 30, it is only necessary to calculate correction amounts C′₄ and C′₉ that minimize an RMS value F_{RMS} given by:

F_{RMS}²(C′₄,C′₉)=Σ(W′_{XY-Axis}(ρi))²=Σ(6C₂₈ρᵢ⁶+(6C′₉+C₁₇−5C₂₈)ρᵢ⁴+(2C′₄−6C′₉)ρᵢ²)² (6)

where ρᵢ=(i−1)/(n−1) when i=1, 2, . . . , n (n is a natural number larger than 1), and Σ represents a sum for i.

When, for example, n=21, the correction values C′₄ and C′₉ that minimize the RMS value R_{RMS} are calculated by:

C′₄=−(½)×C₁₇−0.29×C₂₈ (7)

C′₉=−(⅙)×C₁₇−0.58×C₂₈ (8)

The main control unit 120 calculates the driving amount of the optical element 302 of the projection optical system 30, which is necessary to obtain the correction values C′₄ and C′₉ given by equations (7) and (8). In accordance with the calculated driving amount, the main control unit 120 drives the optical element 302 via the projection system control unit 100 and lens driving unit 70. Note that, for example, the main control unit 120 has, in its memory, information representing the relationship between the correction values C′₄ and C′₉ and the driving amount of the optical element 302 of the projection optical system 30, which is necessary to obtain the correction values C′₄ and C′₉. Hence, the main control unit 120 can calculate the driving amount of the optical element 302 by referring to this information.

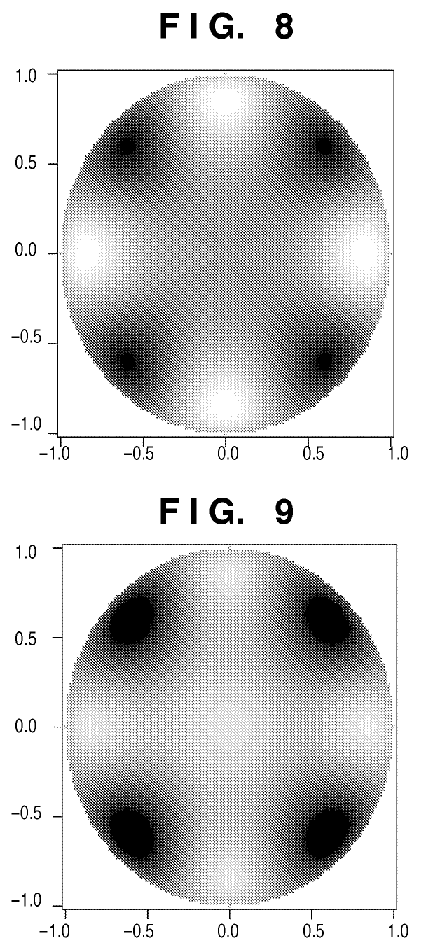

FIG. 9 is a chart showing the aberration W′(ρ, θ) of the projection optical system 30 after aberration correction in step S1008. FIG. 10 is a graph showing the sections of the aberrations W(ρ, θ) and W′(ρ, θ) of the projection optical system 30 shown in FIGS. 8 and 9, respectively, on the X-axis. In FIG. 10, the ordinate indicates the aberration of the projection optical system 30, and the abscissa indicates the normalized pupil radius ρ. As can be understood by referring to FIGS. 9 and 10, the aberration components on the X-axis of the pupil plane of the projection optical system 30 are corrected satisfactorily (that is, the wavefront is flattened). The section of the aberration W′(ρ, θ) of the projection optical system 30 shown in FIG. 9 on the Y-axis is the same as in FIG. 10, and a detailed description thereof will not be given herein.

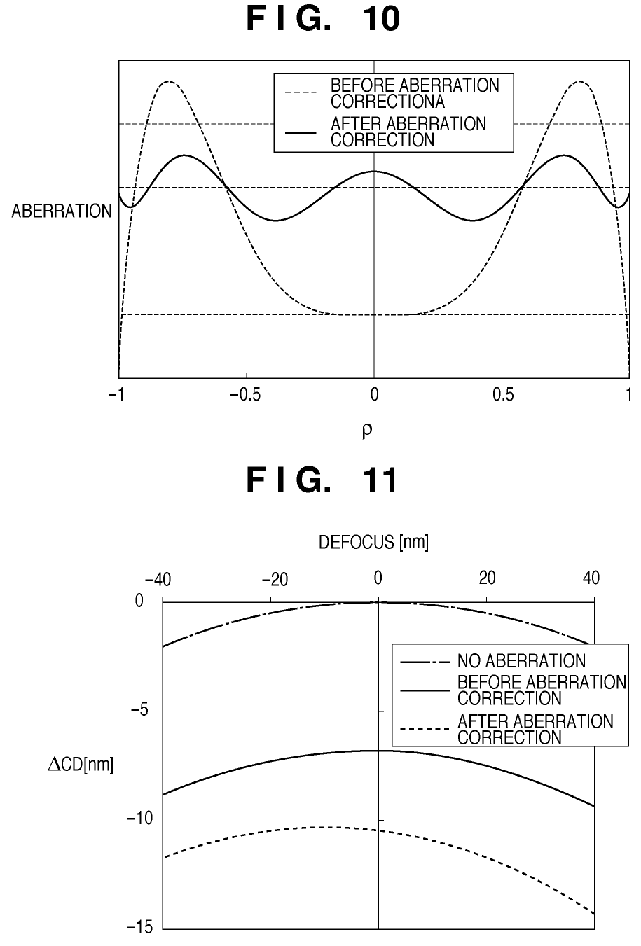

FIG. 11 is a graph showing a variation ΔCD in the line width of the main pattern PT₁ when the reticle 20 shown in FIG. 6 is exposed. In FIG. 11, the ordinate indicates the variation ΔCD in line width, and the abscissa indicates the defocus. FIG. 11 exemplifies a case in which a projection optical system 30 having no aberration is used, that in which a projection optical system 30 before the aberration correction according to this embodiment is used, and that in which a projection optical system 30 after the aberration correction according to this embodiment is used. As can be understood by referring to FIG. 11, when the projection optical system 30 after the aberration correction according to this embodiment is used, the variation ΔCD in line width is small as compared with the case in which the projection optical system 30 before the aberration correction according to this embodiment is used.

In this manner, the exposure apparatus 1 according to this embodiment can attain excellent imaging characteristics by accurately adjusting the imaging state (e.g., the aberration) of light which passes through the projection optical system 30.

Instead of giving the correction values C′₄ and C′₉ so as to correct the aberration components expressed by the Zernike coefficients of the 17th term (C₁₇) and 28th term (C₂₈) at once, they can be given so as to correct only the aberration component expressed by the Zernike coefficient of the 17th term (C₁₇). A case in which only the aberration component expressed by the Zernike coefficient of the 17th term (C₁₇) is corrected in the partial region CA₁ on the pupil plane of the projection optical system 30 will be exemplified below.

FIG. 12 is a chart showing the aberration W(ρ, θ) of the projection optical system 30 before aberration correction. Note that in FIG. 12, the aberration W(ρ, θ) is normalized assuming the aberration component expressed by the Zernike coefficient of the 17th term (C₁₇) as 1. The aberration W(ρ, θ) of the projection optical system 30 is given by:

W(ρ,θ)=C₁₇·Z₁₇(ρ,θ)=C₁₇·ρ⁴ cos 4θ (9)

To correct the aberration component expressed by the Zernike coefficient of the 17th term (C₁₇), aberration components (correction amounts) C′₄ and C′₉ expressed by the Zernike coefficients of the 4th and 9th terms are given. Then, a wavefront aberration W′(ρ, θ) of the projection optical system 30 is given by:

W′(ρ,θ)=C₁₇·ρ⁴ cos 4θ+C′₄(2ρ²)+C′₉(6ρ⁴−6ρ²) (10)

Note that a constant term is ignored because it does not exert an influence on the imaging state of light which passes through the projection optical system 30.

An aberration W′_{XY-Axis}(ρ) on the X- and Y-axes (θ=0, ρ/2, π, 3π/2) of the pupil plane of the projection optical system 30 is given by:

W′_{XY-Axis}(ρ)=C₁₇·ρ⁴+C′₄(2ρ²)+C′₉(6ρ⁴6ρ²) (11)

Equation (11) is rewritten as a polynomial for the normalized pupil radius ρ:

W′_{XY-Axis}(ρ)=(6C′₉+C₁₇)ρ⁴+(2C′₄−6C′₉)ρ²+(−C′₄+6C′₉) (12)

Based on a condition under which the 4th and 2nd terms of the normalized pupil radius p are zero, the correction amounts C′₄ and C′₉ are calculated by:

C′₄=−(½)×C₁₇ (13)

C′₉=−(⅙)×C₁₇ (14)

The main control unit 120 calculates the driving amount of the optical element 302 of the projection optical system 30, which is necessary to obtain the correction values C′₄ and C′₉ given by equations (13) and (14). In accordance with the calculated driving amount, the main control unit 120 drives the optical element 302 via the projection system control unit 100 and lens driving unit 70.

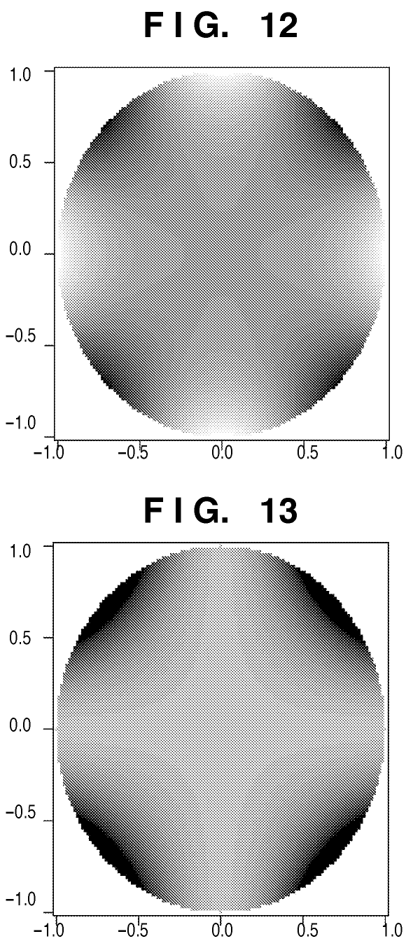

FIG. 13 is a chart showing the aberration W′(ρ, θ) of the projection optical system 30 after aberration correction in the partial region CA₁ on the pupil plane of the projection optical system 30. As can be understood by referring to FIG. 13, the aberration in the partial region CA₁ on the pupil plane of the projection optical system 30 is small as compared with the aberration W(ρ, θ) of the projection optical system 30 before the aberration shown in FIG. 12 is corrected.

This embodiment does not limit the pattern of the reticle 20 and an effective light source (the shape of an effective light source) formed by the illumination optical system 14. For example, the illumination optical system 14 may form an effective light source (the shape of an effective light source) as shown in FIG. 14 on the pupil plane of the projection optical system 30. The effective light source shown in FIG. 14 has a dipole shape having light intensity distributions LID in two divided regions on a first axis (on the X-axis) in the pupil plane of the projection optical system 30. Also, the effective light source shown in FIG. 14 is obtained by extracting an annular zone defined by σ=0.90 and an annular ratio=4/5 at an extraction angle=30°. Note that FIG. 14 is a view showing an example of the shape of an effective light source formed by the illumination optical system 14.

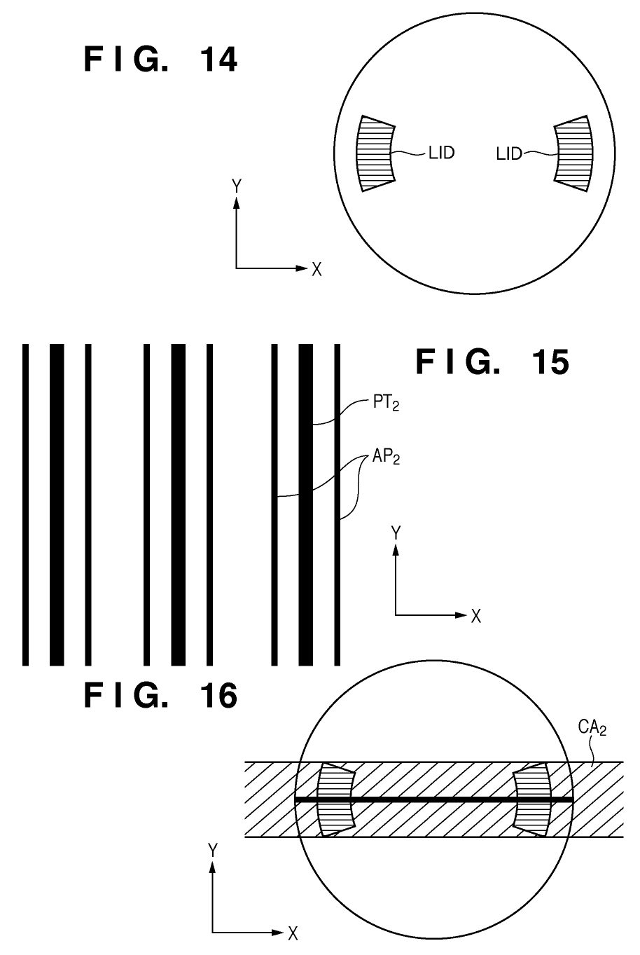

FIG. 15 is a view showing the pattern of a reticle 20 used for (the shape of) the effective light source shown in FIG. 14. The reticle 20 shown in FIG. 15 has a main pattern PT₂ parallel to the Y-axis, and auxiliary patterns AP₂ formed on both sides of the main pattern PT₂. As described above, because the main pattern PT₂ of the reticle 20 is parallel to the Y-axis, light diffracted by the reticle 20 (main pattern PT₂) propagates in the X-axis direction.

In this case, the main control unit 120 specifies a partial region CA₂ on the pupil plane of the projection optical system 30 as shown in FIG. 16, based on the pattern of the reticle 20 shown in FIG. 15 and the shape of the effective light source shown in FIG. 14. The partial region CA₂ is a region irradiated with light diffracted by the main pattern PT₂ of the reticle 20 shown in FIG. 15 on the pupil plane of the projection optical system 30. The light diffracted by the main pattern PT₂ of the reticle 20 shown in FIG. 15 is distributed near the X-axis on the pupil plane of the projection optical system 30. In this manner, the main control unit 120 specifies, as the partial region CA₂, a band-like region which extends in the X-axis direction and includes two regions in which the light intensity distributions LID are formed. Note that FIG. 16 is a view showing the partial region CA₂ on the pupil plane of the projection optical system 30, which is specified from the pattern of the reticle 20 shown in FIG. 15 and the shape of the effective light source shown in FIG. 14.

As shown in FIG. 16, if the distribution of light diffracted by the reticle 20 is asymmetrical in the X- and Y-axis directions, generally large 2θ-system aberration components (e.g., the Zernike coefficients of the 5th term (C₅) and 12th term (C₁₂)) are generated in the projection optical system 30 due to exposure heat generation. However, the aberration correcting mechanism in the exposure apparatus according to this embodiment cannot correct (reduce) the aberration components expressed by, for example, the Zernike coefficients of the 5th term (C₅) and 12th term (C₁₂) (aberration components rotationally asymmetrical about the optical axis of the projection optical system 30). To solve this problem, in this embodiment, the aberration components expressed by the Zernike coefficients of the 5th term (C₅) and 12th term (C₁₂) are corrected by the aberration components expressed by the Zernike coefficients of the 4th term (C₄) and 9th term (C₉) in the partial region CA₂ on the pupil plane of the projection optical system 30.

A case in which the aberration component expressed by the Zernike coefficient of the 12th term (C₁₂) is corrected in the partial region CA₂ on the pupil plane of the projection optical system 30 will be exemplified below. Assume that correction only in a region on the X-axis of the pupil plane of the projection optical system 30 amounts to correction over the entire region CA₂ herein. This assumption can be established because the region CA₂ lies near the X-axis, which can facilitate the calculation.

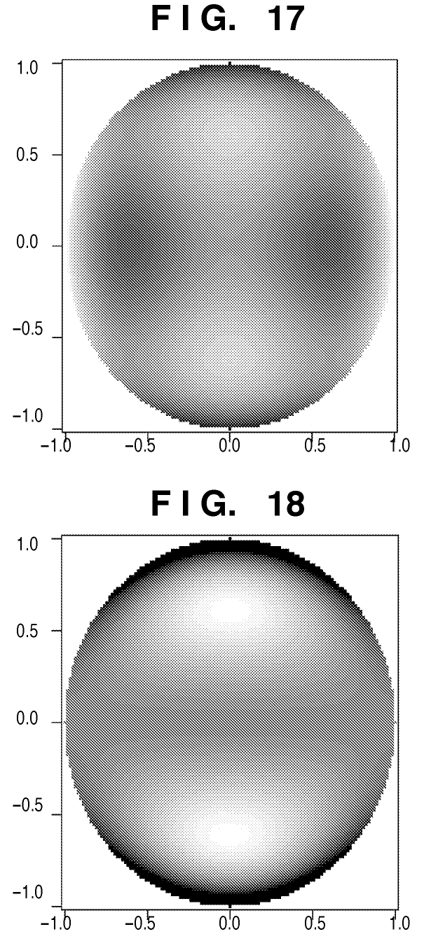

FIG. 17 is a chart showing the aberration W(ρ, θ) of the projection optical system 30 before aberration correction. Note that in FIG. 17, the aberration W(ρ, θ) is normalized assuming the aberration component expressed by the Zernike coefficient of the 12th term (C₁₂) as 1. The aberration W(ρ, θ) of the projection optical system 30 is given by:

W(ρ,θ)=C₁₂·Z₁₂(ρ,θ)=C₁₂(4ρ⁴−3ρ²)cos 2θ (15)

To correct the aberration component expressed by the Zernike coefficient of the 12th term (C₁₂), aberration components (correction amounts) C′₄ and C′₉ expressed by the Zernike coefficients of the 4th and 9th terms are given. Then, a wavefront aberration W′(ρ, θ) of the projection optical system 30 is given by:

W′(ρ,θ)=C₁₂(4ρ⁴−3ρ²)cos 2θ+C′₄(2ρ²)+C′₉(6ρ⁴−6ρ²) (16)

Note that a constant term is ignored because it does not exert an influence on the imaging state of light which passes through the projection optical system 30.

An aberration W′_{X-Axis}(ρ) on the X-axis (θ=0, π) of the pupil plane of the projection optical system 30 is given by:

W′_{X-Axis}(ρ)=C₁₂(4ρ⁴−3ρ²)+C′₄(2ρ²)+C′₉(6ρ⁴−6ρ²) (17)

Equation (17) is rewritten as a polynomial for the normalized pupil radius ρ:

W′_{X-Axis}(ρ)=(6C′₉+4C₁₂)ρ⁴+(2C₄−6C′₉−3C₁₂)ρ²+(−C′₄+6C′₉) (18)

Based on a condition under which the 4th and 2nd terms of the normalized pupil radius p are zero, the correction amounts C′₄ and C′₉ are calculated by:

C′₄=−(½)×C₁₂ (19)

C′₉=−(⅔)×C₁₂ (20)

The main control unit 120 calculates the driving amount of the optical element 302 of the projection optical system 30, which is necessary to obtain the correction values C′₄ and C′₉ given by equations (19) and (20). In accordance with the calculated driving amount, the main control unit 120 drives the optical element 302 via the projection system control unit 100 and lens driving unit 70.

FIG. 18 is a chart showing the aberration W′(ρ, θ) of the projection optical system 30 after aberration correction in the partial region CA₂ on the pupil plane of the projection optical system 30. As can be understood by referring to FIG. 18, the aberration in the partial region CA₂ on the pupil plane of the projection optical system 30 is small as compared with the aberration W(ρ, θ) of the projection optical system 30 before the aberration shown in FIG. 17 is corrected.

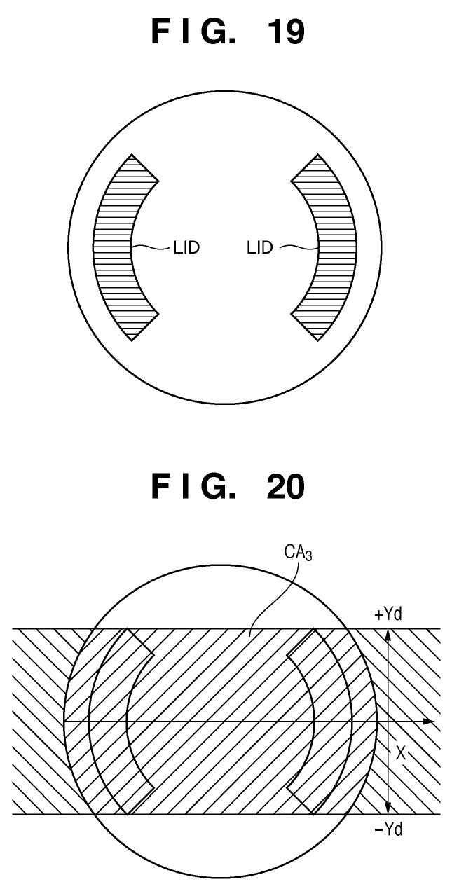

(The shape of) The effective light source shown in FIG. 14 can be substituted by (the shape of) the effective light source shown in FIG. 19. The effective light source shown in FIG. 19 has a dipole shape having light intensity distributions LID in two divided regions on a first axis (on the X-axis) in the pupil plane of the projection optical system 30. Also, the effective light source shown in FIG. 19 is obtained by extracting an annular zone defined by G=0.90 and an annular ratio=4/5 at an extraction angle=90°. Note that FIG. 19 is a view showing an example of the shape of an effective light source formed by the illumination optical system 14.

If the reticle 20 shown in FIG. 15 is illuminated by the effective light source shown in FIG. 19, light diffracted by the reticle 20 (main pattern PT₂) propagates in the X-axis direction. Because the effective light source shown in FIG. 19 is obtained at a larger extraction angle than that shown in FIG. 14, the light diffracted by the reticle 20 diverges even in the Y-axis direction.

In this case, the main control unit 120 specifies a partial region CA₃ on the pupil plane of the projection optical system 30 as shown in FIG. 20, based on the pattern of the reticle 20 shown in FIG. 15 and the shape of the effective light source shown in FIG. 19. The partial region CA₃ is a region irradiated with light diffracted by the main pattern PT₂ of the reticle 20 shown in FIG. 15 on the pupil plane of the projection optical system 30. In this manner, the main control unit 120 specifies, as the partial region CA₃, a band-like region which extends in the X-axis direction and includes two regions in which the light intensity distributions LID are formed. Note that FIG. 20 is a view showing the partial region CA₃ on the pupil plane of the projection optical system 30, which is specified from the pattern of the reticle 20 shown in FIG. 15 and the shape of the effective light source shown in FIG. 19.

As shown in FIG. 20, a Y-coordinate Y_{d} as a point on the effective light source, that is farthest from the X-axis, on the pupil plane of the projection optical system 30 is given by:

Y_{d}=σ×sin α (21)

In this embodiment, the Y-coordinate Y_{d} is 0.9×1/√2≈0.64. Accordingly, light diffracted by the reticle 20 (main pattern PT₂) is distributed while diverging across the range of ±Y_{d} from the X-axis on the pupil plane of the projection optical system 30. Although the aberration of the projection optical system 30 may be corrected on the X-axis of the pupil plane of the projection optical system 30 as described above, the correction effect is expected to be small. In view of this, the aberration of the projection optical system 30 is preferably corrected in the partial region CA₃ across the range of ±Y_{d} from the X-axis on the pupil plane of the projection optical system 30.

A case in which the aberration of the projection optical system 30 is corrected in the partial region CA₃ on the pupil plane of the projection optical system 30 will be exemplified below.

Assume that aberration components (correction amounts) C′₄ and C′₉ expressed by the Zernike coefficients of the 4th and 9th terms are given. Then, using the wavefront W(ρ, θ) of the projection optical system 30 before aberration correction, a wavefront aberration W′(ρ, θ) of the projection optical system 30 is given by:

W′(ρ,θ)=W(ρ,θ)+C′₄(2ρ²)+C′₉(6ρ⁴−6ρ²) (22)

Note that a constant term is ignored because it does not exert an influence on the imaging state of light which passes through the projection optical system 30.

In this embodiment, correction amounts C′₄ and C′₉ that minimize an RMS value F_{RMS} given by:

F_{RMS}²(C′₄,C′₉)=Σ(W′(ρᵢ,θᵢ))² (23)

are calculated, where (ρᵢ, θᵢ) is an arbitrary point included in the partial region CA₃ on the pupil plane of the projection optical system 30 when i=1, 2, . . . , n (n is a natural number larger than 1), and Σ represents a sum for i.

Note that the RMS value F_{RMS} is the RMS value of the aberrations calculated at n representative points included in the partial region CA₃ on the pupil plane of the projection optical system 30.

The main control unit 120 calculates the driving amount of the optical element 302 of the projection optical system 30, which is necessary to obtain the correction values C′₄ and C′₉ given by equation (23). In accordance with the calculated driving amount, the main control unit 120 drives the optical element 302 via the projection system control unit 100 and lens driving unit 70.

Although the correction of aberration generated in the projection optical system 30 due to the exposure heat generation of the lens has been exemplified in this embodiment, the present invention is applicable to other types of aberrations. For example, a case in which the wavefront aberration W(ρ, θ) of the projection optical system 30 is corrected in a certain region S on the pupil plane of the projection optical system 30 by giving the aberration components expressed by the Zernike coefficients of the 4th to 36th terms will be considered. In this case, the correction value of each term can be calculated as a set of correction amounts C′ₖ (k=4 to 36) that minimize an RMS value F_{RMS} given by:

$${F}_{RMS} ( {C}_{4}^{′} , {C}_{5}^{′} , {C}_{6}^{′} , … , {C}_{36}^{′} ) = \sqrt{{{\sum }_{i}}^{n} {[ w ( {ρ}_{i} , {θ}_{i} ) + {\sum }_{k = 4}^{36} {C}_{k}^{′} {Z}_{k} ( {ρ}_{i} , {θ}_{i} ) ]}^{2}} \qquad ( 24 )$$

where Zₖ(ρ, θ) is the kth term of the Zernike orthogonal cylindrical function system, C′ₖ is the correction value of the Zernike coefficient of the kth term, and (ρᵢ, θᵢ) is the coordinates of the ith evaluation point (i=1, 2, . . . , n) included in the region S.

In exposure, light from the light source 12 illuminates the reticle 20 via the illumination optical system 14. The light which bears the information of the pattern of the reticle 20 forms an image on the wafer 40 by the projection optical system 30. The aberration of the projection optical system 30 used for the exposure apparatus 1 is accurately adjusted (corrected) in a partial region on the pupil plane of the projection optical system 30, thus attaining an excellent imaging performance. Hence, the exposure apparatus 1 can provide high-quality devices (e.g., a semiconductor device and liquid crystal device) with a high throughput and a good economical efficiency. These devices are fabricated by a step of exposing a substrate (e.g., a wafer or glass plate) coated with a photoresist (photosensitive agent) using the exposure apparatus 1, a step of developing the exposed substrate, and other known steps.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-326584 filed on Dec. 18, 2007, which is hereby incorporated by reference herein in its entirety.

What is claimed is:

1. An exposure apparatus comprising:
a projection optical system configured to project a pattern of a reticle onto a substrate;
a specifying unit configured to specify a first region on a pupil plane of said projection optical system based on the pattern of the reticle and a shape of an effective light source on the pupil plane of said projection optical system; and
an adjusting unit configured to adjust an aberration of said projection optical system,
wherein said adjusting unit adjusts the aberration of said projection optical system so that an aberration in the first region specified by said specifying unit becomes smaller than an aberration in a second region on the pupil plane of said projection optical system, which is different from the first region.

2. The apparatus according to claim 1, wherein the first region is a region irradiated with light diffracted by the pattern of the reticle.

3. The apparatus according to claim 1, wherein the first region is one of a point region, a line region, a plane region, and a combination thereof.

4. The apparatus according to claim 1, wherein if the effective light source has a dipole shape having light intensity distributions in two divided regions on a first axis in the pupil plane of said projection optical system, said specifying unit specifies, as the first region, a band region which extends in a direction of the first axis and includes the two regions.

5. The apparatus according to claim 1, wherein if the effective light source has a quadrupole shape having light intensity distributions in two divided regions on a first axis in the pupil plane of said projection optical system, and two divided regions on a second axis, in the pupil plane, perpendicular to the first axis, said specifying unit specifies, as the first region, a band region which extends in a direction of the first axis and includes the two divided regions on the first axis, and a band region which extends in a direction of the second axis and includes the two divided regions on the second axis.

6. The apparatus according to claim 1, wherein said adjusting unit adjusts the aberration of said projection optical system by driving an optical element which forms said projection optical system.

7. The apparatus according to claim 6, wherein the driving of said optical element by said adjusting unit includes one of driving of said optical element in a direction of an optical axis of said projection optical system, tilting of said optical element with respect to a plane perpendicular to the optical axis of said projection optical system, and deformation of said optical element.

8. The apparatus according to claim 1, wherein said adjusting unit adjusts an aberration component, which is rotationally symmetrical about an optical axis of said projection optical system, of the aberration of said projection optical system.

9. The apparatus according to claim 8, wherein when the aberration of said projection optical system is expressed by a Zernike polynomial, said adjusting unit adjusts aberration components corresponding to Zernike coefficients of a 4th term and 9th term.

10. The apparatus according to claim 1, wherein
said specifying unit includes a table representing a correspondence between the pattern of the reticle and the shape of the effective light source on the pupil plane of said projection optical system, and
said specifying unit specifies the first region by referring to said table.

11. An exposure method using an exposure apparatus including a projection optical system which projects a pattern of a reticle onto a substrate, comprising:
a specifying step of specifying a first region on a pupil plane of the projection optical system based on the pattern of the reticle and a shape of an effective light source on the pupil plane of the projection optical system; and
an adjusting step of adjusting an aberration of the projection optical system,
wherein in the adjusting step, the aberration of the projection optical system is adjusted so that an aberration in the first region specified in the specifying step becomes smaller than an aberration in a second region on the pupil plane of the projection optical system, which is different from the first region.

12. A device fabrication method comprising steps of:
exposing a substrate using an exposure apparatus; and
performing a development process for the substrate exposed,
wherein said exposure apparatus includes:
a projection optical system configured to project a pattern of a reticle onto the substrate;
a specifying unit configured to specify a first region on a pupil plane of said projection optical system based on the pattern of the reticle and a shape of an effective light source on the pupil plane of said projection optical system; and
an adjusting unit configured to adjust an aberration of said projection optical system,
wherein said adjusting unit adjusts the aberration of said projection optical system so that an aberration in the first region specified by said specifying unit becomes smaller than an aberration in a second region on the pupil plane of said projection optical system, which is different from the first region.
